(19) United States
(12) Patent Application Publication
(10) Pub. No.: US 2021/0406484 A1
(43) Pub. Date: Dec. 30, 2021

(54) System and Method for a Natural Language Processing Tool

(71) Applicant: Seam Social Labs, New York, NY (US)

(72) Inventor: Tiasia O'Brien, New York, NY (US)

(21) Appl. No.: 17/359,144

(22) Filed: Jun. 25, 2021

Related U.S. Application Data
(60) Provisional application No. 63/043,922, filed on Jun. 25, 2020.

(51) Int. Cl. G06F 40/58; G06F 40/205; G06F 40/30

(52) U.S. Cl. CPC G06F 40/58; G06F 40/30; G06F 40/205

(57) ABSTRACT

A system and a method are provided for a natural language processing (NLP) tool that helps answer complex human questions about community needs. The system includes at least one remote server that manages at least one user account and a database engine. The user account is associated with a user personal computing (PC) device. The remote server is a central computing device that serves information to other computing devices. The user account allows an individual to communicate with the remote server. The database engine processes information in order to output a report to the individual associated to the user account. The remote server manages at least one community-based research topic. The community-based research topic includes qualitative topic-related data. The database engine processes the qualitative topic-related data in order to output insights to complex human questions about community needs.

The current application claims a priority to the U.S. Provisional Patent application Ser. No. 63/043,922 filed on Jun. 25, 2020.

### FIELD OF THE INVENTION

The present invention relates generally to natural language processing (NLP) tools. More specifically, the present invention is a method for an NLP tool that helps answer complex human questions about community needs based on qualitative community data.

### BACKGROUND OF THE INVENTION

The present invention is a natural language processing (NLP) tool for inducing insights on qualitative data collected from individuals in order to determine sentiments related to their communities, cultural connections, and preservation goals. The present invention is different from current methods in the training of the machine learning model, use of partially labeled data, and empirical risk minimization to infer outputs. In order to develop such an NLP tool with accuracy, the present invention utilizes empirical risk minimization with sentiment classification that is not related to social or review data, but rather with what the present invention identifies as economic data, historical data, and social platform data. These datasets will require large historical and cultural genre classifications to train the machine learning model to infer from a mix of supervised and unsupervised data while reducing generalization and increasing the variance of outputs. A query (to import data, filter data, to update data) is converted with a hypertext preprocessor (PHP) interpreter to the standard query language (SQL) database engine using SQL syntax, and data is returned, typically in the form of an array or associative array. Further manipulation with the PHP interpreter can format the data to be transmitted as hypertext markup language (HTML) content. Finally, through communication with a hypertext transfer protocol (HTTP) Server, this dynamically formatted HTML data is then sent to a user's web browser.

### BRIEF DESCRIPTION OF THE DRAWINGS

FIG. 1 is a diagram displaying the system of the present invention.

FIG. 2A is a flowchart illustrating the overall process for the method of the present invention.

FIG. 2B is a continuation of FIG. 2A.

FIG. 3 is a flowchart illustrating the subprocess for generating the plurality of sociologically-categorized datasets with the text classifier.

FIG. 4 is a flowchart illustrating the subprocess for extracting the topic insight from the qualitative topic-related data.

FIG. 5 is a flowchart illustrating the subprocess for specifically extracting a topic insight for a sentiment dataset.

FIG. 6 is a flowchart illustrating the subprocess for separating the topic insights of each sociologically-categorized dataset based on geospatial location.

FIG. 7 is a flowchart illustrating the subprocess for converting the qualitative topic-related data into a machine language input.

FIG. 8 is a flowchart illustrating the subprocess for converting a machine language output into a human-language output.

FIG. 9 is a flowchart illustrating the subprocess for retrieving the qualitative topic-related data.

### DETAIL DESCRIPTIONS OF THE INVENTION

All illustrations of the drawings are for the purpose of describing selected versions of the present invention and are not intended to limit the scope of the present invention.

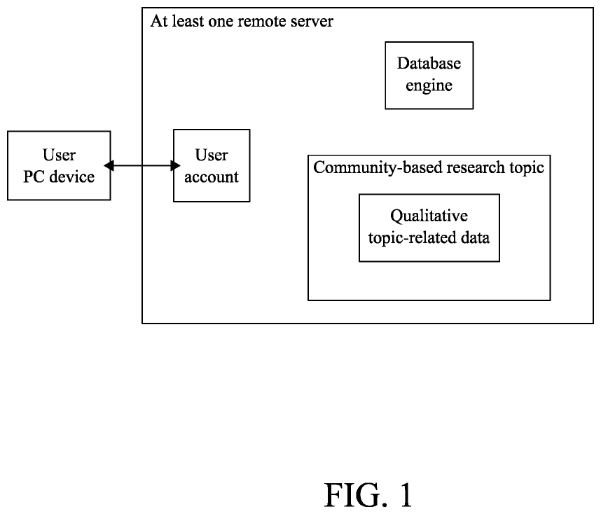

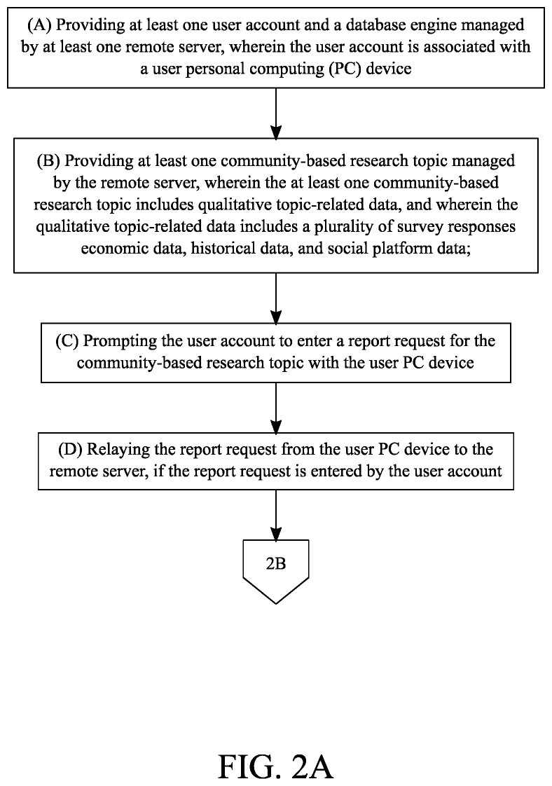

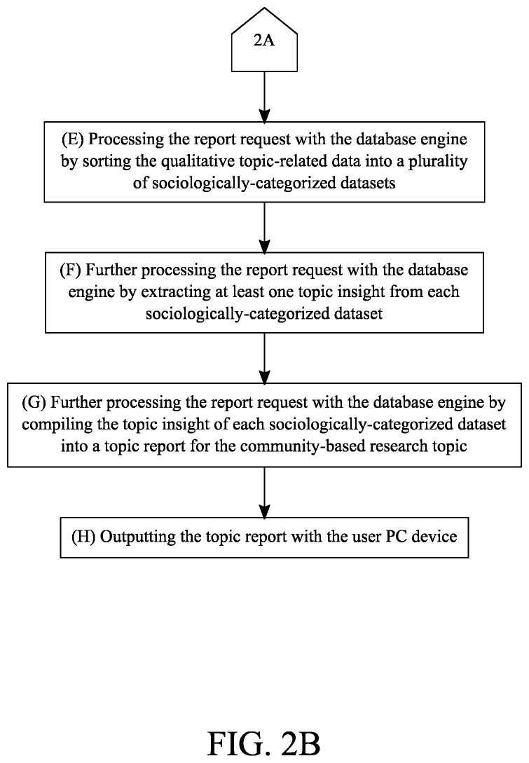

In reference to FIGS. 1 through 9, the present invention is a system and method for a natural language processing (NLP) tool that helps answer complex human questions about community needs. Although the present invention is primarily an NLP tool, the present invention can be used for various types of data processing. With reference to FIGS. 1 and 2A, the system of the present invention includes at least one remote server that manages at least one user account and a database engine (Step A). The user account is associated with a user personal computing (PC) device. The remote server is a central computing device that serves information to other computing devices. The user account allows an individual to interact with the present invention. The database engine processes information in order to output a report to the individual associated to the user account. Preferably, the database engine is a standard query language (SQL) database engine. The user PC device may be any computing device such as, but not limited to, a desktop computer, notebook computer, a mobile tablet, or a smartphone that allows an individual to communicate with the remote server. Further, the remote server manages at least one community-based research topic (Step B). The community-based research topic may be any topic relevant to communities such as, but not limited to, air quality, crime, poverty, or homelessness. The community-based research topic includes qualitative topic-related data. The qualitative topic-related data is unstructured and/or open-ended data that includes a plurality of survey responses, economic data, historical data, and social platform data.

The method of the present invention follows an overall process for answering complex human questions about community needs. With reference to FIGS. 2A and 2B, the user PC device prompts the user account to enter a report request for the community-based research topic (Step C). The report request is an input communicating that the user account desires to receive a report on a community-based research topic. The report request is then relayed from the user PC device to the remote server, if the report request is entered by the user account (Step D). Thus, the remote server is given instructions to process data and output a report on a community-based research topic. The database engine processes the report request by sorting the qualitative topic-related data into a plurality of sociologically-categorized datasets (Step E). The plurality of sociologically-categorized datasets is a group of datasets categorized based on sociological aspects derived from human data. The database engine further processes the report request by extracting at least one topic insight from each sociological-categorized dataset (Step F). The topic insight is preferably an answer to complex human questions about community needs. The database engine further processes the report request by compiling the topic insight of each sociological-categorized dataset into a topic report for the community-based research topic. The topic report is a document that includes at least one answer to complex human questions about community needs. Finally, the user PC device outputs the topic report. In more detail, the topic report is displayed to the individual associated to the user account.

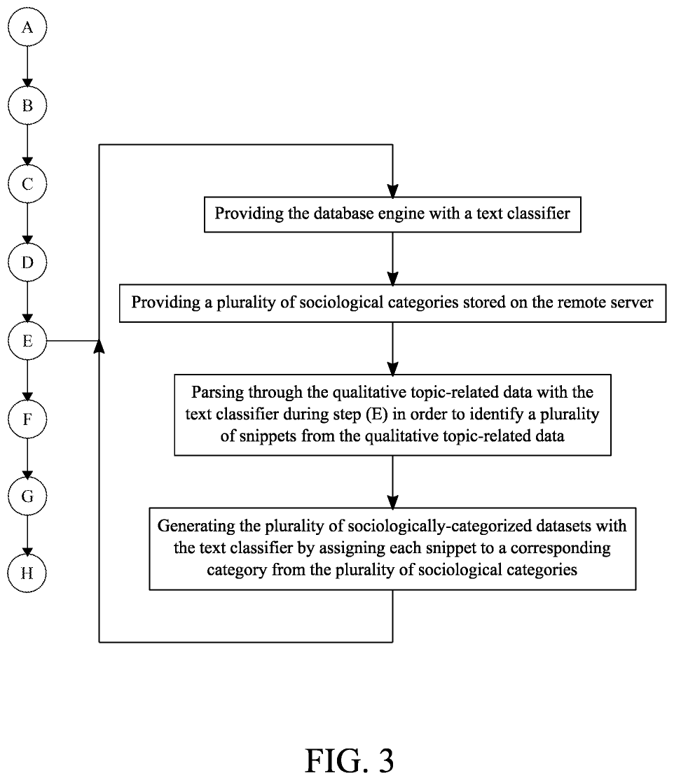

In order for the database engine to generate the plurality of sociologically-categorized datasets and with reference to FIG. 3, the following subprocess is executed. The database engine is provided with a text classifier. The text classifier is a machine learning feature of the database engine used to categorize data into organized groups. A plurality of sociological categories is stored on the remote server. Preferably, the plurality of sociological categories includes a behavior category, an attitude category, a condition category, a sentiment category, and a solution category. The text classifier parses through the qualitative topic-related data during Step E in order to identify a plurality of snippets from the qualitative topic-related data. The plurality of snippets is a set of word pieces that are taken from sentences found in the qualitative topic-related data. The text classifier generates the plurality of sociologically-categorized datasets by assigning each snippet to a corresponding category from the plurality of sociological categories. Thus, the database engine generates the plurality of sociologically-categorized datasets in preparation to process the plurality of sociologically-categorized datasets.

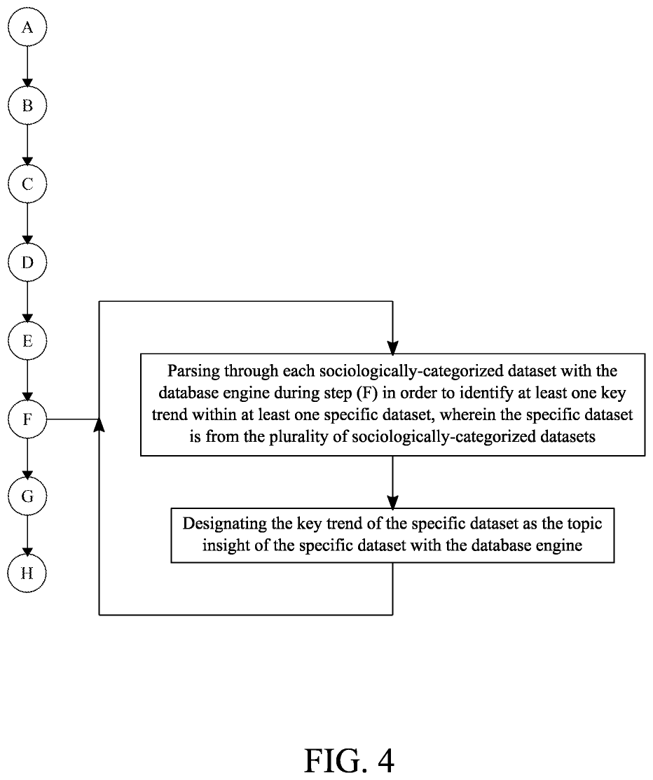

In order for the database engine to extract the topic insight from each sociologically-categorized dataset and with reference to FIG. 4, the following subprocess is executed. The database engine parses through each sociologically-categorized dataset during Step F in order to identify at least one key trend within at least one specific dataset. The specific dataset is from the plurality sociologically-categorized datasets. The key trend is a piece of information such as a common phrase derived from the specific dataset. The database engine then designates the key trend of the specific dataset as the topic insight of the specific dataset. Thus, the database engine extracts the topic insight from each sociologically-categorized dataset.

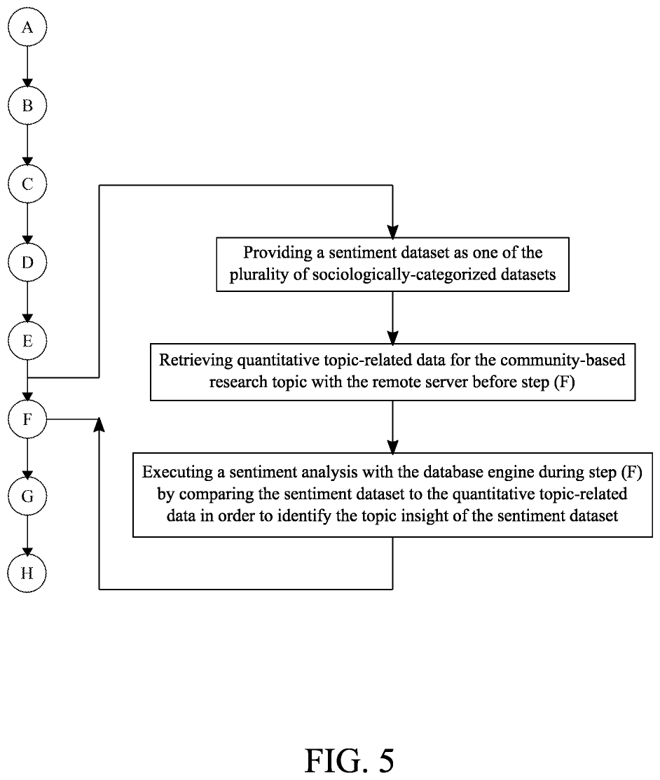

Alternatively and with reference to FIG. 5, the database engine can specifically extract a topic insight for a sentiment dataset through the following subprocess. The sentiment dataset is provided as one of the plurality of sociologically-categorized datasets. The remote server retrieves quantitative topic-related data for the community-based research topic before Step F. The quantitative topic-related data can be retrieved from application programming interface (API) integrated data that is relayed from a secondary remote server. The database engine executes a sentiment analysis during Step F by comparing the sentiment dataset to the quantitative topic-related data in order to identify the topic insight of the sentiment dataset. Thus, the database engine can specifically extract a topic insight for a sentiment dataset.

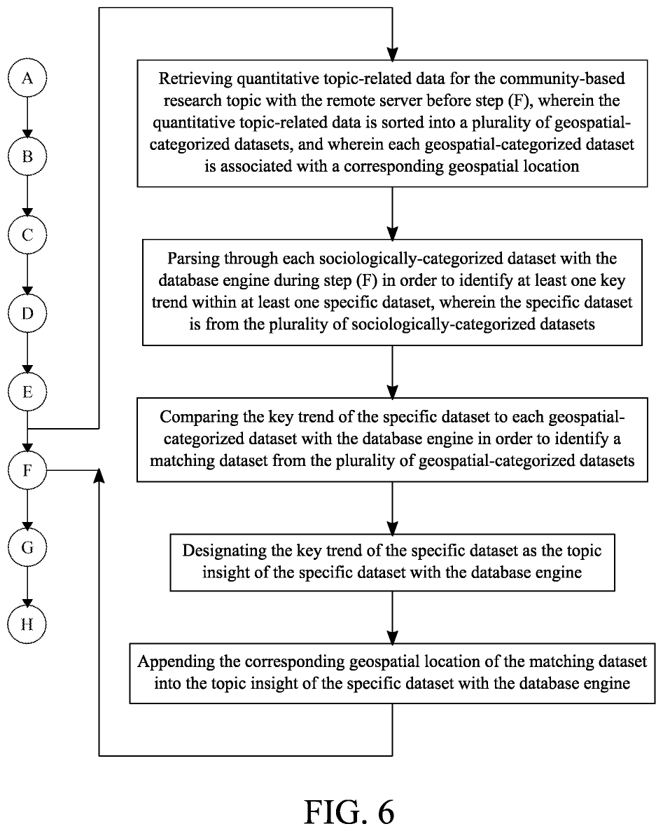

In order for the database engine to separate the topic insights of each sociologically-categorized dataset based on geospatial location and with reference to FIG. 6, the following subprocess is executed. The remote server retrieves quantitative topic-related data for the community-based research topic with the remote server before Step F. Preferably, the quantitative topic-related data is sorted into a plurality of geospatial-categorized datasets. Each geospatial-categorized dataset is associated with a corresponding geospatial location. More specifically, the geospatial location can be any type of geospatial location identified by a city, zip code, state, etc. The database engine parses through each sociologically-categorized dataset during Step F in order to identify at least one key trend within at least one specific dataset. Then, the database engine compares the key trend of the specific dataset to each geospatial-categorized dataset in order to identify a matching dataset from the plurality of geospatial-categorized datasets. In more detail, the database engine attempts to relate geospatial locations with the key trends. The database engine designates the key trend of the specific dataset as the topic insight of the specific dataset. Moreover, the database engine appends the corresponding geospatial location of the matching dataset into the topic insight of the specific dataset. Thus, the database engine separates the topic insights of each sociologically-categorized dataset based on geospatial location.

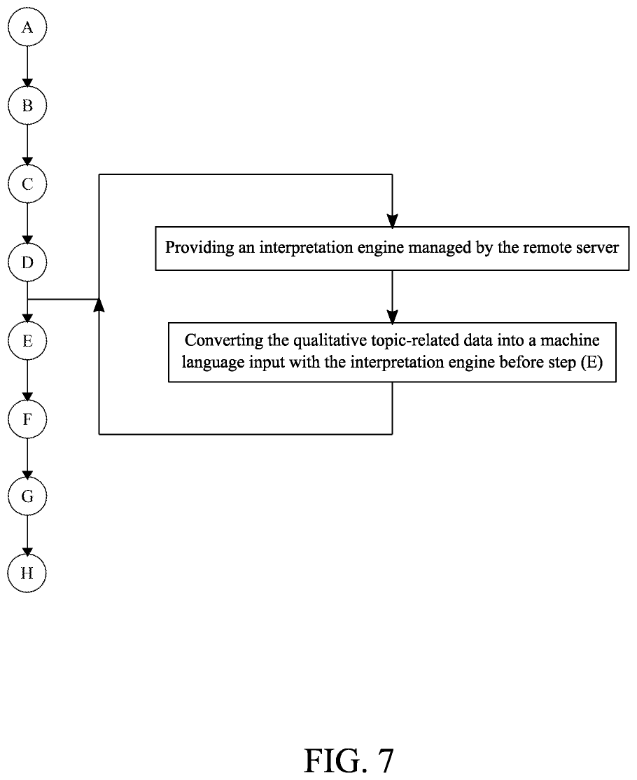

In order for the database engine to be able to comprehend the qualitative topic-related data and with reference to FIG. 7, the following subprocess is executed. An interpretation engine is managed by the remote server. Preferably, the interpretation engine is a hypertext preprocessor (PHP) interpreter. The interpretation engine converts the qualitative topic-related data into a machine language input before Step E. Preferably, the machine language input is in SQL format. Thus, the database engine is able to comprehend the qualitative topic-related data.

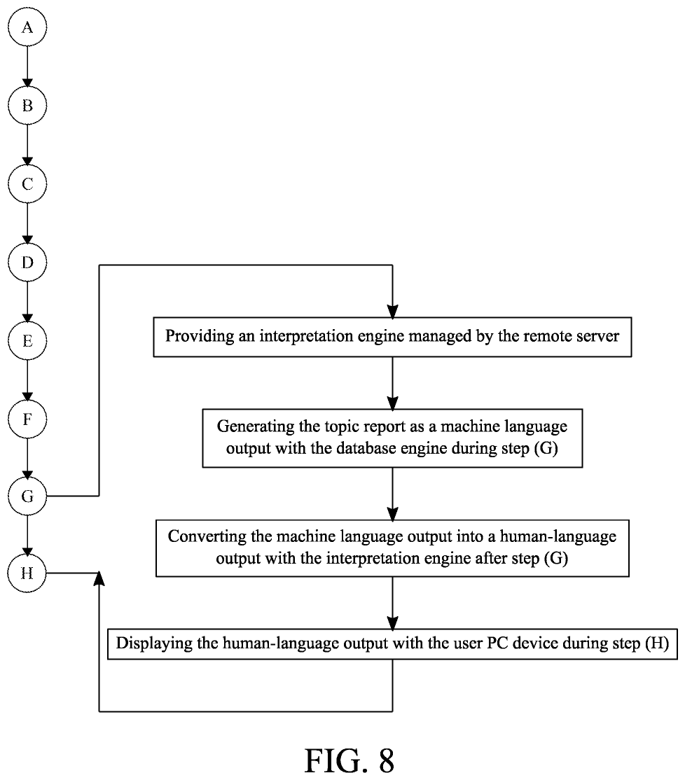

In order for the individual associated to the user account to be able to comprehend the topic report and with reference to FIG. 8, the following subprocess is executed. The database engine generates the topic report as a machine language output during Step G. The machine language output is the topic report in SQL format. The interpretation engine converts the machine language output into a human-language output after Step G. Preferably, the human-language output is in hypertext markup language (HTML) format. Finally, the user PC device displays the human-language output during Step H. Thus, the individual associated to the user account is able to comprehend the topic report.

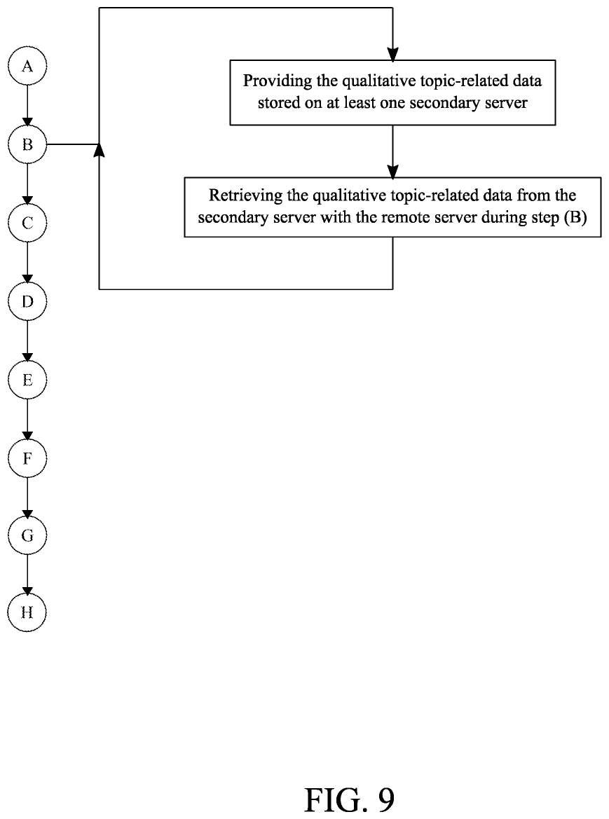

In order for the remote server to be provided with the qualitative topic-related data and with reference to FIG. 9, the following subprocess is executed. The qualitative topic-related data is stored on at least one secondary server. The secondary sever includes an API to receive qualitative topic-related data from users. The remote server retrieves the qualitative topic-related data from the secondary server during Step B. More specifically, the qualitative topic-related data is retrieved as API integrated data. Thus, the remote server is provided with the qualitative topic-related data.

In order to train the text classifier, the present invention employs a semi-supervised deep structured learning method. The remote server manages a supervisor account, wherein the supervisor account is associated with a supervisor PC device. The supervisor account is preferably used by a research scientist. The supervisor PC device prompts the supervisor account to partially label the qualitative topic-related data in order to produce a set of one or more sociologically-categorized datasets. The remote server generates the one or more sociologically-categorized datasets that are analyzed by text classifier in order to execute the deep structured learning method.

Although the invention has been explained in relation to its preferred embodiment, it is to be understood that many other possible modifications and variations can be made without departing from the spirit and scope of the invention as hereinafter claimed.

What is claimed is:

1. A method for a natural language processing tool, the method comprising the steps of:
(A) providing at least one user account and a database engine managed by at least one remote server, wherein the user account is associated with a user personal computing (PC) device;
(B) providing at least one community-based research topic managed by the remote server, wherein the at least one community-based research topic includes qualitative topic-related data, and wherein the qualitative topic-related data includes a plurality of survey responses, economic data, historical data, and social platform data;
(C) prompting the user account to enter a report request for the community-based research topic with the user PC device;
(D) relaying the report request from the user PC device to the remote server, if the report request is entered by the user account;
(E) processing the report request with the database engine by sorting the qualitative topic-related data into a plurality of sociologically-categorized datasets;
(F) further processing the report request with the database engine by extracting at least one topic insight from each sociologically-categorized dataset;
(G) further processing the report request with the database engine by compiling the topic insight of each sociologically-categorized dataset into a topic report for the community-based research topic; and
(H) outputting the topic report with the user PC device.

2. The method for a natural language processing tool, the method as claimed in claim 1 comprising the steps of:
providing the database engine with a text classifier;
providing a plurality of sociological categories stored on the remote server;
parsing through the qualitative topic-related data with the text classifier during step (E) in order to identify a plurality of snippets from the qualitative topic-related data; and
generating the plurality of sociologically-categorized datasets with the text classifier by assigning each snippet to a corresponding category from the plurality of sociological categories.

3. The method for a natural language processing tool, the method as claimed in claim 2, wherein the plurality of sociological categories includes a behavior category, an attitude category, a condition category, a sentiment category, and a solution category.

4. The method for a natural language processing tool, the method as claimed in claim 1 comprising the steps of:
parsing through each sociologically-categorized dataset with the database engine during step (F) in order to identify at least one key trend within at least one specific dataset, wherein the specific dataset is from the plurality of sociologically-categorized datasets; and
designating the key trend of the specific dataset as the topic insight of the specific dataset with the database engine.

5. The method for a natural language processing tool, the method as claimed in claim 1 comprising the steps of:
providing a sentiment dataset as one of the plurality of sociologically-categorized datasets;
retrieving quantitative topic-related data for the community-based research topic with the remote server before step (F); and
executing a sentiment analysis with the database engine during step (F) by comparing the sentiment dataset to the quantitative topic-related data in order to identify the topic insight of the sentiment dataset.

6. The method for a natural language processing tool, the method as claimed in claim 1 comprising the steps of:
retrieving quantitative topic-related data for the community-based research topic with the remote server before step (F), wherein the quantitative topic-related data is sorted into a plurality of geospatial-categorized datasets, and wherein each geospatial-categorized dataset is associated with a corresponding geospatial location;
parsing through each sociologically-categorized dataset with the database engine during step (F) in order to identify at least one key trend within at least one specific dataset, wherein the specific dataset is from the plurality of sociologically-categorized datasets;
comparing the key trend of the specific dataset to each geospatial-categorized dataset with the database engine in order to identify a matching dataset from the plurality of geospatial-categorized datasets;
designating the key trend of the specific dataset as the topic insight of the specific dataset with the database engine; and
appending the corresponding geospatial location of the matching dataset into the topic insight of the specific dataset with the database engine.

7. The method for a natural language processing tool, the method as claimed in claim 1 comprising the steps of:
providing an interpretation engine managed by the remote server; and
converting the qualitative topic-related data into a machine language input with the interpretation engine before step (E).

8. The method for a natural language processing tool, the method as claimed in claim 7, wherein the machine language input is in standard query language (SQL) format.

9. The method for a natural language processing tool, the method as claimed in claim 1 comprising the steps of:
providing an interpretation engine managed by the remote server;
generating the topic report as a machine language output with the database engine during step (G);
converting the machine language output into a human-language output with the interpretation engine after step (G); and
displaying the human-language output with the user PC device during step (H).

10. The method for a natural language processing tool, the method as claimed in claim 9, wherein the human-language output is in hypertext markup language (HTML) format.

11. The method for a natural language processing tool, the method as claimed in claim 1, the method comprising the steps of:
providing the qualitative topic-related data stored on at least one secondary server; and
retrieving the qualitative topic-related data from the secondary server with the remote server during step (B).
